(19) United States
(12) Patent Application Publication
(10) Pub. No.: US 2006/0165852 A1
(43) Pub. Date: Jul. 27, 2006

(54) Asian fast-food packs embodied by its accompanying cooked rice, and a method of distribution

(76) Inventor: Sang K. Sheem, Pleasanton, CA (US)

Correspondence Address: SANG K. SHEEM, 1790 PASEO DEL CAJON, PLEASANTON, CA, 94566, US

(21) Appl. No.: 11/043,617

(22) Filed: Jan. 26, 2005

(51) Int. Cl. A21D 10/02

(52) U.S. Cl. 426/112

(57) ABSTRACT

Novel Asian fast-food packing means and the distribution means are disclosed in which the rice traditionally accompanying the Asian meals is employed as the basic supporting medium and the strengthening member in defining and retaining the shape of the fast-food packs.

This patent application is a continuation-in-part application of provisional patent applications 60/549,261, titled, “ASIAN FAST-FOOD PACKS EMBODIED BY THE ACCOMPANYING COOKED RICE”, and 60/540,684, titled, “FAST-FOOD PACKAGING OF ORIENTAL MEALS, AND METHOD OF DISTRIBUTION”.

### TECHNICAL FIELD

This invention relates to fast-food meals.

### BACKGROUND ART

This patent application deals only with Asian dishes that are juicy with sauces, and that are served with cooked rice traditionally. In such traditional Asian meals, the sauces are salty or/and strongly flavored, and cooked rice is needed to neutralize the taste.

As the social mobility increases, it is desirable to develop fast-food items that could satisfy the need of people on the go. However, the presence of Asian meals is insignificant in the fast-food business sector.

A popular Western meal is a steak served with breads. Hamburger resembles it: meat between bread buns.

Such convenient conversion is not easy for the Asian meals under consideration, namely, Asian dishes accompanied by cooked rice. Unlike steak, such a meal is soak-wet with a sauce, and quite fragmented. The juicy sauces often carry strong smell and color, and the fragmented pieces could fall down. If such an Asian is to be packaged into a hand-held fast-food pack improperly, eating it could become quite quickly.

The referred patent application Ser. No. 60/540,684, titled, “FAST-FOOD PACKAGING OF ORIENTAL MEALS, AND METHOD OF DISTRIBUTION” teaches a fast-food packing means, in which ingredients are prepared and cooked in small sizes, and enclosed inside a wrapping medium.

On one hand, since the wrapping medium is a foreign element, being absent in the traditional Asian dish, it is desirable that the wrap is rather thin and of a minimal amount so as not to interfere with the traditional taste of the dish.

On the other hand, the wrap should be strong and resilient enough to withstand the handling by humans, and the wetting by the sauce.

These two requirements are mutually contradicting, necessitating certain optimization effort in choosing the wrap material, determining the thickness, and devising the packaging process.

Also, the size of the fast-food packs should remain rather small: a bite size or close to it. Otherwise, the packs could lose their firmness and the shape, and even get wet, torn, and messy, during the handling and eating. This could be prevented if the wrap is quite thick. But then the taste is altered.

Accordingly, it is desirable to come up with a packing means that could be applicable to a large size fast-food pack as well as to a bite-size. A large size fast-food pack is desirable in some circumstances.

By the way, another consideration is the shape of the fast-food packs. Wontons and egg-rolls are wrapped manually, as have been done over thousands of years, and it shows. People do not mind the traditional shapes of the wontons and egg-rolls in an Asian restaurant. However, if Asian meals are to become bona fide fast-food items that are universally accepted, especially by young people, and are to be consumed in a public place such as an office or a ballpark, at any time of the day, the shape should look more ‘modern’. The shape should have a look that appears having been produced by a machine, not by human fingers. Preferred shape would be of oval, cylindrical, spherical, cubical, rectangular, or cubical.

### SUMMARY OF THE INVENTION

Accordingly, it is the objective of this patent application to devise novel Asian fast-food embodiments that satisfy the requirements listed above, including the needs for bigger size fast-food packs and desirability of ‘modern’ geometrical shapes.

This objective is achieved by using the accompanying rice as the basic supporting structure or the strengthening member in defining and retaining the shape of the fast-food packs.

That is, the cooked rice provides the embodiment to a juicy and fragmented Asian dish item.

A wrapping medium is employed when necessary to seal off the juicy and fragmented Asian dish item completely.

Slight browning by heat of the surface makes a lump of cooked rice more rugged in terms of the structural strength.

An embodiment resembling the hamburger bun is also disclosed.

### BRIEF DESCRIPTION OF DRAWINGS

FIG. 1(a) depicts, in a highly schematic and symbolic fashion, two examples of the novel embodiments of Asian fast-food packs.

FIG. 1(b) depicts, in a highly schematic and symbolic fashion, three more examples of the novel embodiments of Asian fast-food packs.

FIGS. 2 (a), (b), and (c) show the rectangular fast-food pack of FIG. 1(a) in three different packing steps.

FIGS. 3 (a), (b), and (c) show the circular fast-food pack shown in FIG. 1(a) in three different packing steps.

FIG. 4 depicts, in a highly schematic and symbolic fashion, the multiple stacks of the rectangular fast-food pack embodiment of FIG. 1(a).

FIG. 5 depicts, in a highly schematic and symbolic fashion, a step in the wrapping process of the fast-food pack shown in FIG. 4.

FIG. 6 is the same as shown in FIG. 5, except that the sectional shape is cylindrical instead of being rectangular.

FIG. 7 shows the elongated Asian fast-food pack of FIG. 5 after the wrapping is completed.

FIG. 8 is the same as shown in FIG. 7, except that the side ends of the pack are covered with a wrap material.

FIG. 9 shows a case in which the locations of the rice and those of the Asian dish item are made distinguishable visually.

FIG. 10 shows another possible embodiment of the present invention.

FIG. 11 shows yet another possible embodiment of the present invention.

FIG. 12 shows an example in which only the cooked rice is employed to construct a sealed reservoir to contain the juicy and fragmented Asian dish item.

FIG. 13 shows another example in which only the rice is employed to construct a sealed reservoir to contain the juicy and fragmented Asian dish item.

FIG. 14 shows a process in which the surface of the rice is coated with a coating material.

FIG. 15 shows an embodiment of a rice reservoir resembling a rice bowl.

FIG. 16 shows the embodiment of FIG. 15 with a cover for the bowl.

FIG. 17 shows the same as in FIG. 16, with the cover on the rice reservoir.

FIG. 18 shows an embodiment resembling the hamburger bun.

FIG. 19 shows the embodiment of FIG. 18 with its pocket filled with an Asian meal.

FIG. 20 shows a distribution method in which the Asian fast-food packs are distributed in frozen state.

FIG. 21 shows a fast-food chain restaurant system in which the Asian fast-food packs are manufactured in a central food processing facility, and then delivered to its member chain stores.

### DETAILED DESCRIPTION

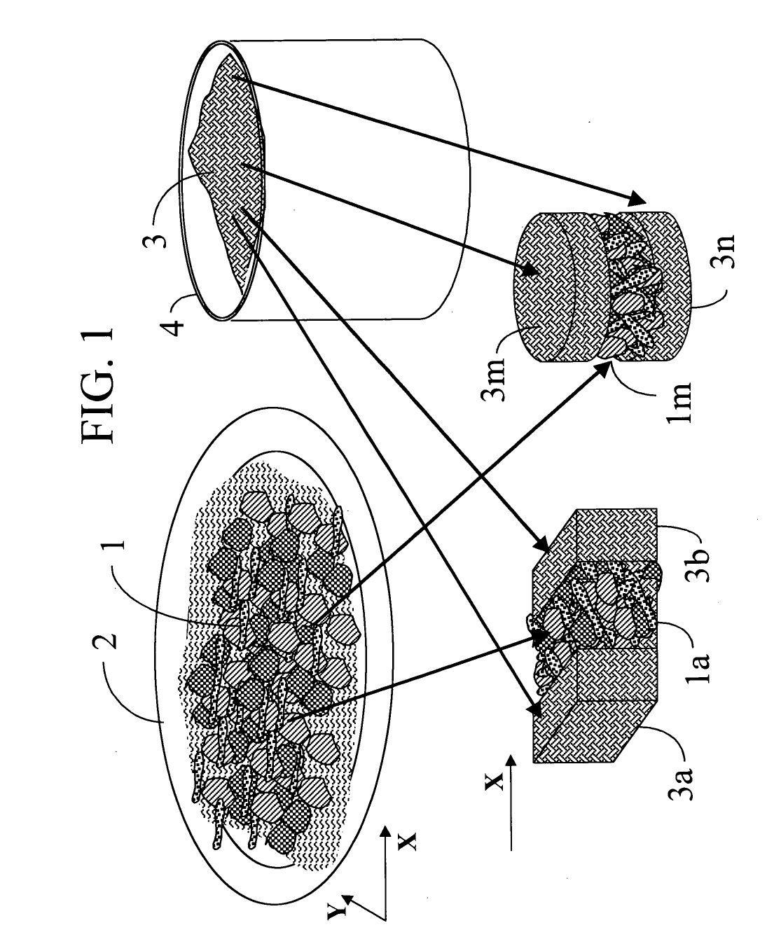

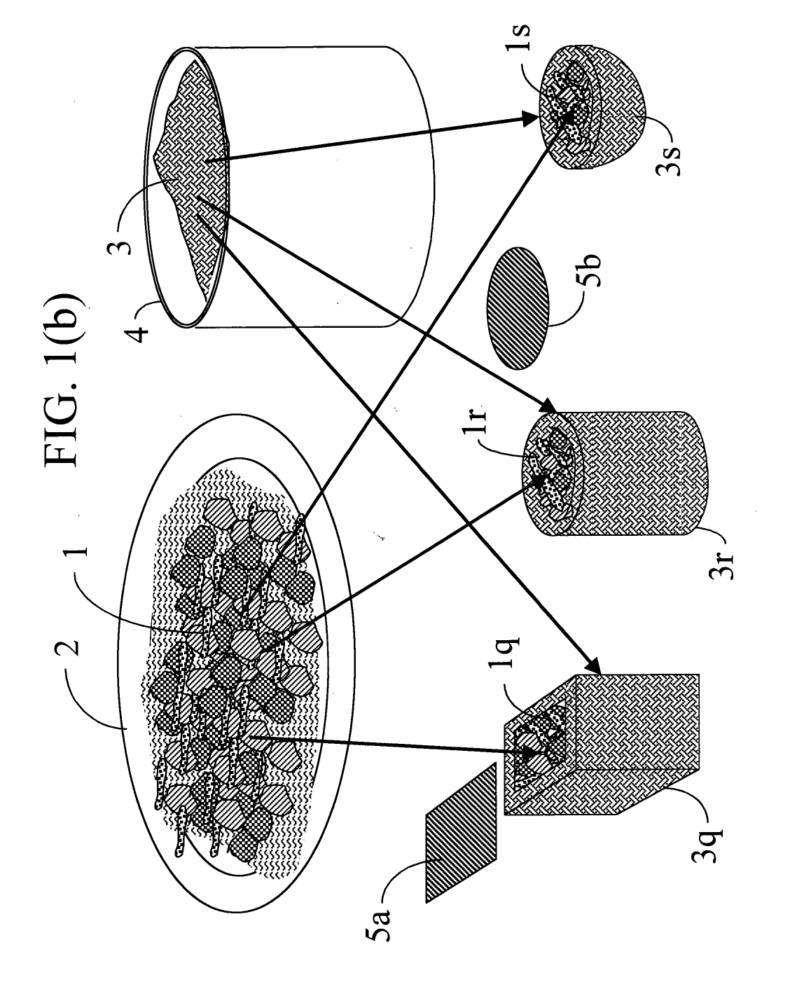

FIG. 1(a) shows two examples of the present invention.

An Asian dish item 1, such as Teriyaki Chicken, Bool-Ko-Ki (marinated and then broiled beef), or Mongolian Beef, is shown on a serving dish 2 in a highly schematic and symbolic fashion.

Such dish items are rather salty or/and strongly flavored, and are traditionally accompanied by a cooked rice 3 contained in a bowl. The rice neutralizes the saltiness and the strong flavor. The rice also provides extra nutrition.

By the way, the sizes of the ingredients of the Asian dish item 1 are often too large or too long to be packaged into a bite-size pack. As described in detail in the referred patent application Ser. No. 60/540,684, titled, “FAST-FOOD PACKAGING OF ORIENTAL MEALS, AND METHOD OF DISTRIBUTION”, the ingredients need to be prepared in smaller sizes in general, and preferably cooked separately. We assume that such measures are taken in this divisional-in-part application.

The Asian dish item 1 is quite juicy and fragmented, and does not have the firmness to form a certain geometrical shape by themselves alone

On the other hand, the cooked rice 3 can be shaped into a certain geometrical form such as a block form 3a and 3b, or cylindrical form 3m and 3n, as depicted in FIG. 1(a).

Then the fragmented and juicy Asian dish item 1 may be inserted into the space 1a (or 1m) created by the lumps of the cooked rice 3a and 3b (or 3m and 3n), as indicated by the arrows in FIG. 1(a).

FIG. 1(a) also shows, on the far left and on the far right, the fast-food packs after they are surrounded with a wrap material 5.

FIG. 1(b) shows some variations in which the cooked rice are shaped into containers, 3q, 3r, and 3s, and the juicy and fragmented Asian dish item 1 is allocated into the spaces 1q, 1r, and 1s, respectively, as the arrows indicate.

A cover 5a or 5b is used to complete the enclosure of the juicy and fragmented Asian dish item 1 in the rice containers 3q, 3r, and 3s.

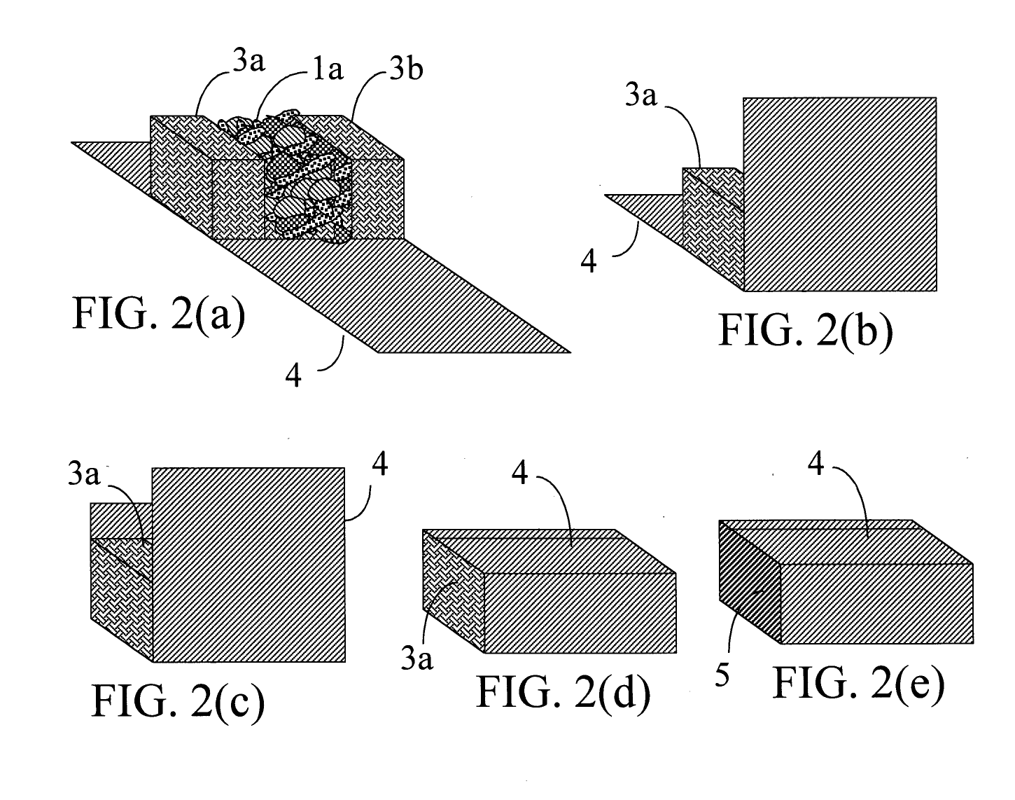

FIG. 2(a) through FIG. 2(c) show, in a highly schematic and symbolic manner, the packaging steps of the block-shaped fast-food embodiment shown on the left side in FIG. 1(a).

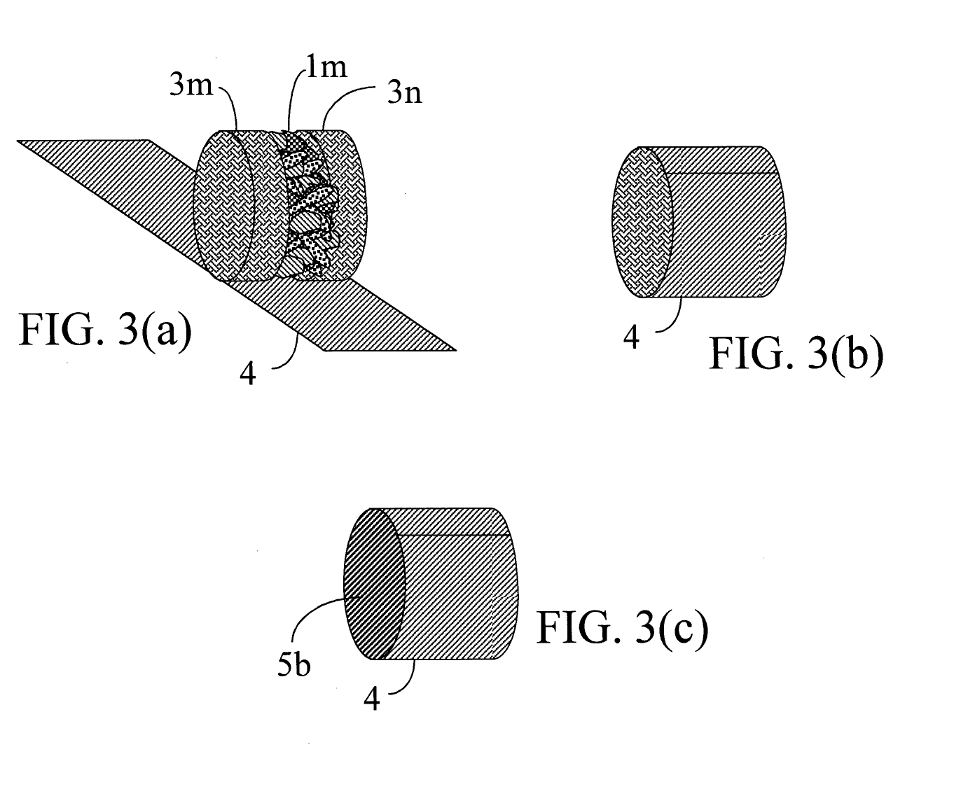

FIG. 3(a) through FIG. 3(c) show, in a highly schematic and symbolic manner, the packaging steps of the cylinder-shaped fast-food embodiment shown on the right side in FIG. 1(a).

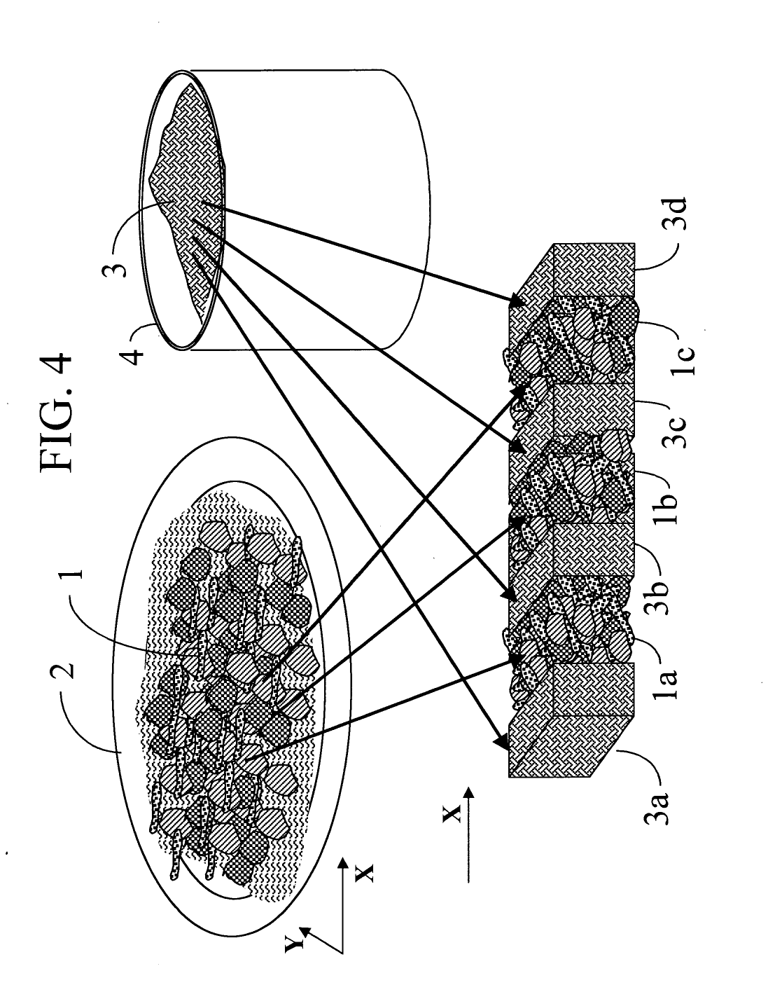

FIG. 4 shows the one-dimensional stacking of the fast-food embodiment of FIG. 1(a), to make an elongated fast-food pack. The process is the simple extension of that of FIG. 1(a), in which blocks of cooked rice, 3a through 3d, create spaces 1a through 1c where the juicy and fragmented Asian dish item 1 is allocated to form an elongated fast-food pack.

One way of looking at this packaging process is a linearization of a traditional meal. When a person eats the Asian meal from the dish 2 and the bowl 4, his chopsticks or forks travel in the two-dimensional space of the X-Y, as indicated in FIG. 4. The elongated fast-food pack, on the other hand, is consumed into one direction, as indicated by the X-axis in FIG. 4. This is the essence of the fast-food packing process of the present invention: the conversion of the traditional meal of the two-dimensional nature to one-dimensional fast-food pack, to produce either short packs as shown in FIGS. 1(a) and (b), or elongated pack as shown in FIG. 4 (and FIG. 6 below).

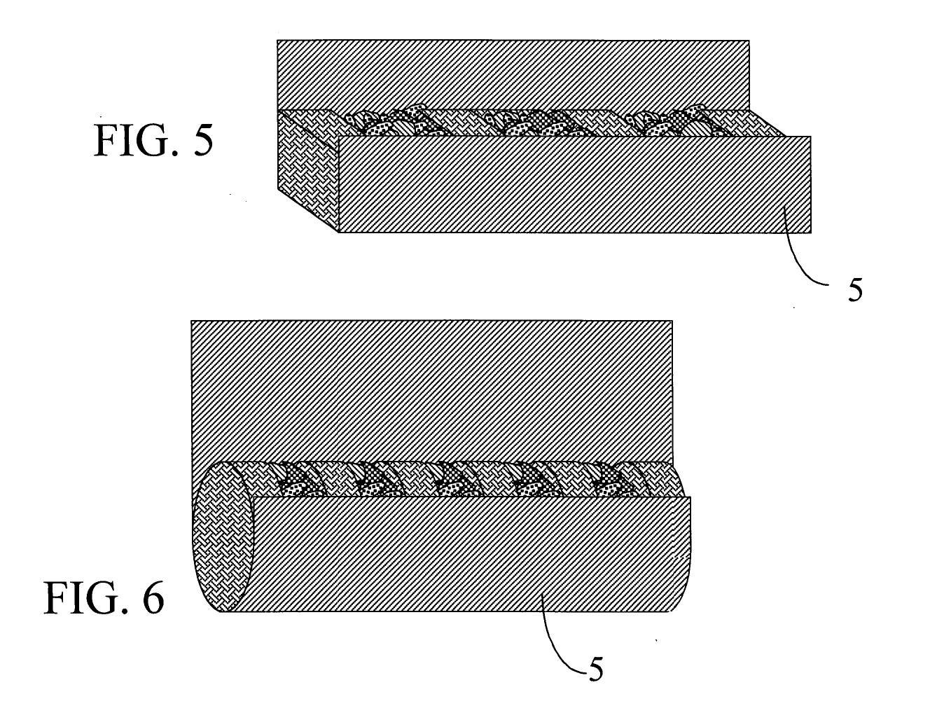

FIG. 5 shows a wrapping process of the elongated fast-food pack of FIG. 4.

FIG. 6 shows the same as shown in FIG. 5, except that it comprises an one-dimensional stack of a plurality of the cylindrical pack of FIG. 1(a).

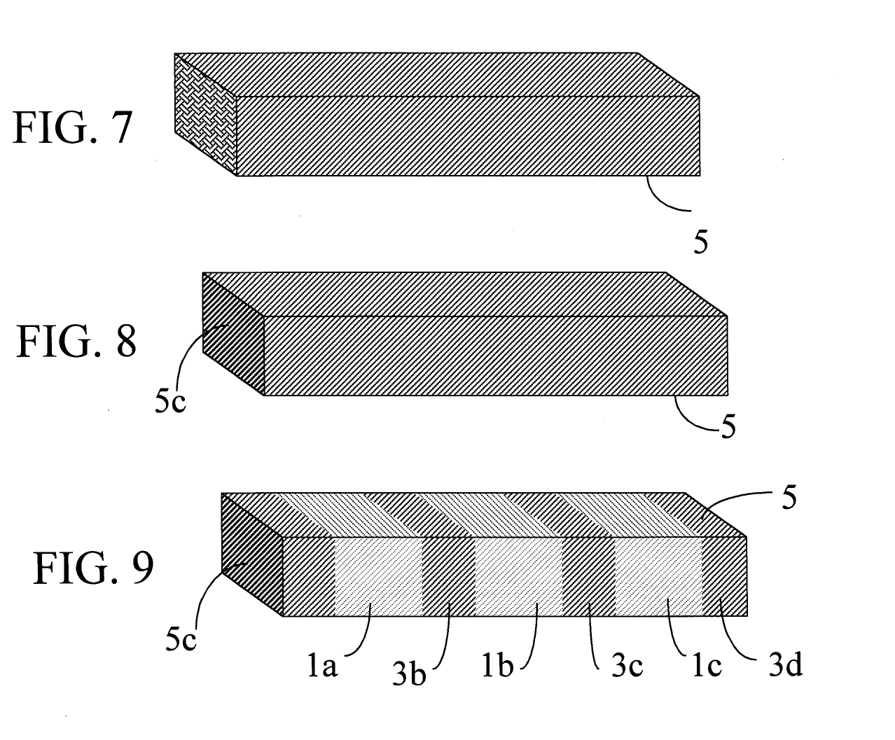

FIG. 7 shows the elongated fast-food pack of FIG. 5 after the wrapping process is completed.

FIG. 8 shows the same after the ends are covered with a wrapping material 5c. Such a cover 5c is optional, and would be added to make the fast-food pack look more professional: exposed rice may not look appealing to some customers. Also, the rice surface is sticky, attracting foreign materials such as dirt more easily.

FIG. 9 is a case in which the layers of the rice blocks, 3a through 3d, and the layers of the Asian dish item, 1a through 1c, are made visually distinguishable from the outside of the wrap 5 for the convenience of the consumers. This is achieved when the wrap 5 is transparent, even partially. Alternatively, markings or some patterns may be added to the surface of the wrap 5.

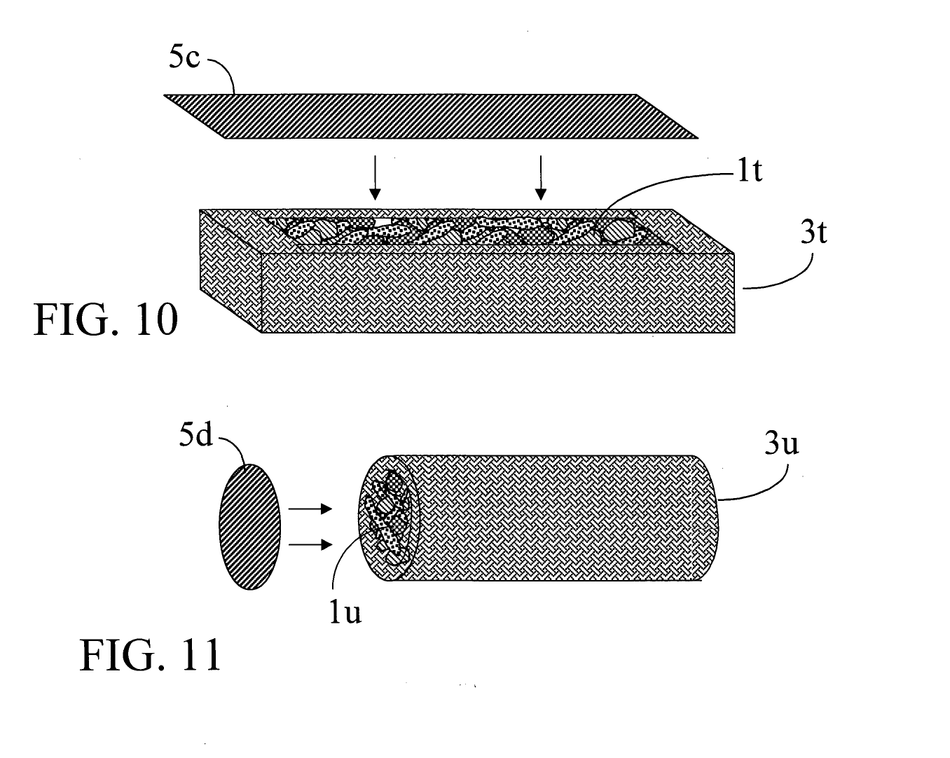

FIG. 10 and FIG. 11 are the simple extension of the embodiments shown in FIG. 1(b) to make elongated fast-food packs. Covers 5d and 5e are used for enclosing the containers 3t and 3u, respectively, thus sealing off the juicy and fragments dish items 1t and 1u.

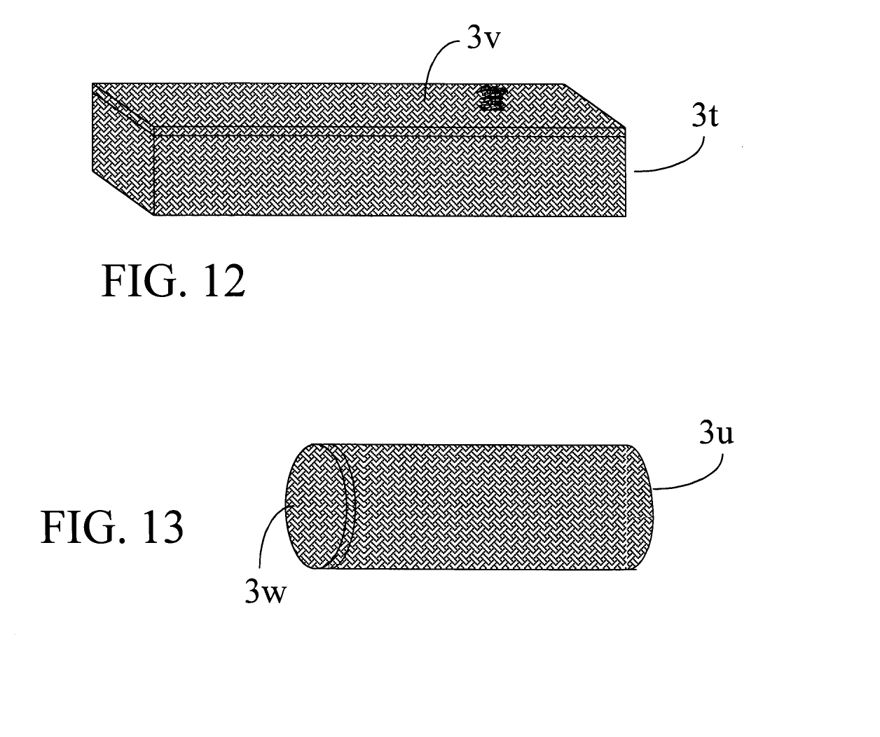

FIG. 12 and FIG. 13 are the cases in which the covers 3v and 3w, respectively, are made of cooked rice also.

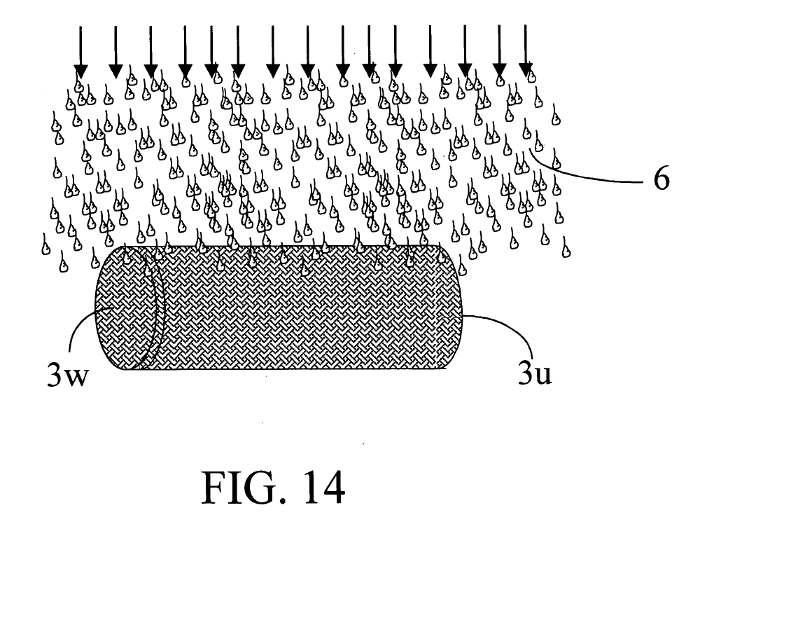

FIG. 14 shows, in a highly schematic and symbolic manner, that the exposed rice such as shown in FIG. 13 is coated with a coating material 6, which would be solidified after the coating process. Such a coating would be preferred if the stickiness of the rice surface is deemed undesirable as a commercial product.

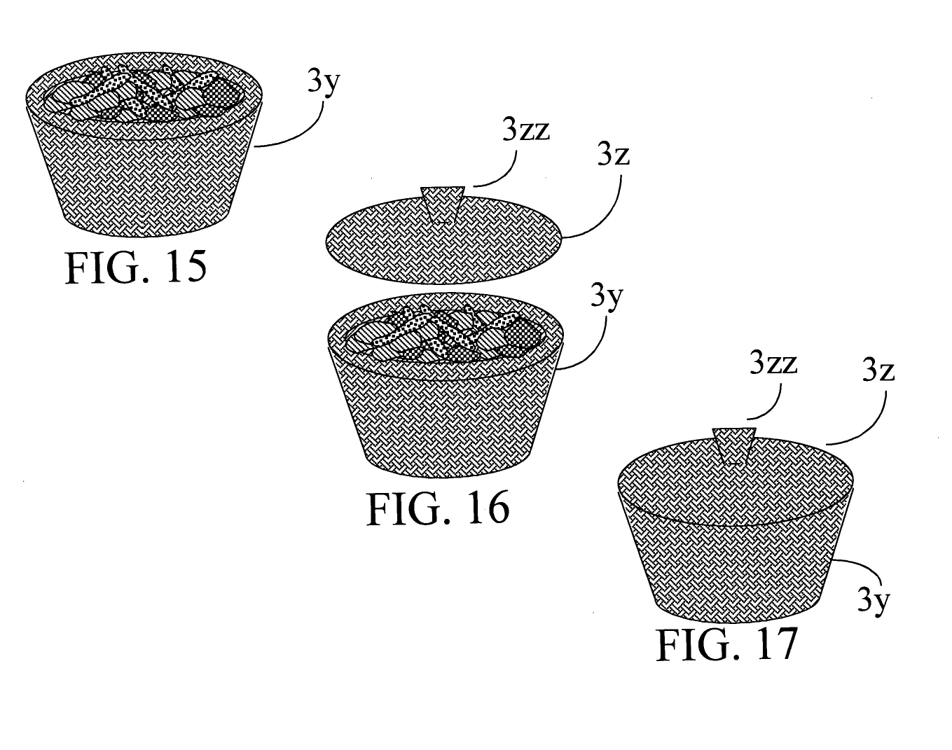

FIG. 15 shows a reservoir 3y, made of cooked rice, that resembles a bowl.

FIG. 16 shows the embodiment of FIG. 15, with a cover 3z, preferably made of cooked rice, and preferably with a handle 3zz.

FIG. 17 shows the same as in FIG. 16, except that the cover 3z is seated over the bowl 3y. Such an embodiment would be attractive, pleasing the consumers' eyes.

In order to make the reservoirs made of cooked rice, depicted above from FIG. 1(a) through FIG. 17, structurally strong and rugged, the surfaces of the reservoirs can be slightly browned. Such a ‘surface browning’ often happens naturally near the surface of the cooking pot as a result of prolonged heating at warm temperature. Such a ‘surface browning’ could be obtained also by heating the pot of cooked rice for a short duration at higher temperature.

Addition of foreign substances into the rice also could help making the rice reservoirs of the present invention stronger and more rugged.

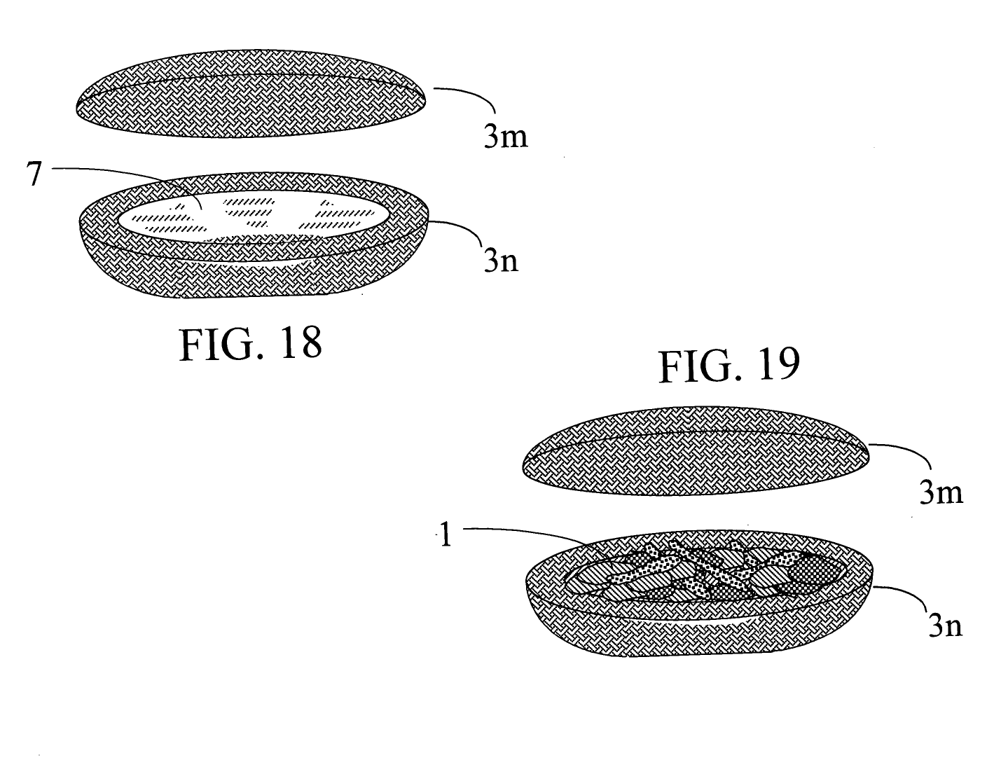

FIG. 18 shows an embodiment resembling the hamburger buns. One side or the both sides of the buns 3n and 3m would have a recess or pocket 7, in which the juicy and/or fragmented ingredients 1 is contained.

The surface of the rice buns in FIG. 18 could have a coating made of flour mixed in water. The coating could be fried on a grill to make it smooth and sturdy. This would make the rice buns 3m and 3n suitable as a finger-food.

The gap between the two buns of FIG. 19 could be sealed together so that the fast-food pack becomes substantially water-tight.

The fast-food packs would get soggy and even spoiled when left on the serving shelf for a prolonged time. Some meals will not be as popular as others, and eventually will get staled and even spoiled. That is why Chinese restaurants cook each dish only after an order is in.

Accordingly, unlike the existing fast-food items, the oriental fast-food items would have to be kept in a frozen state if a full-scale fast-food service is considered.

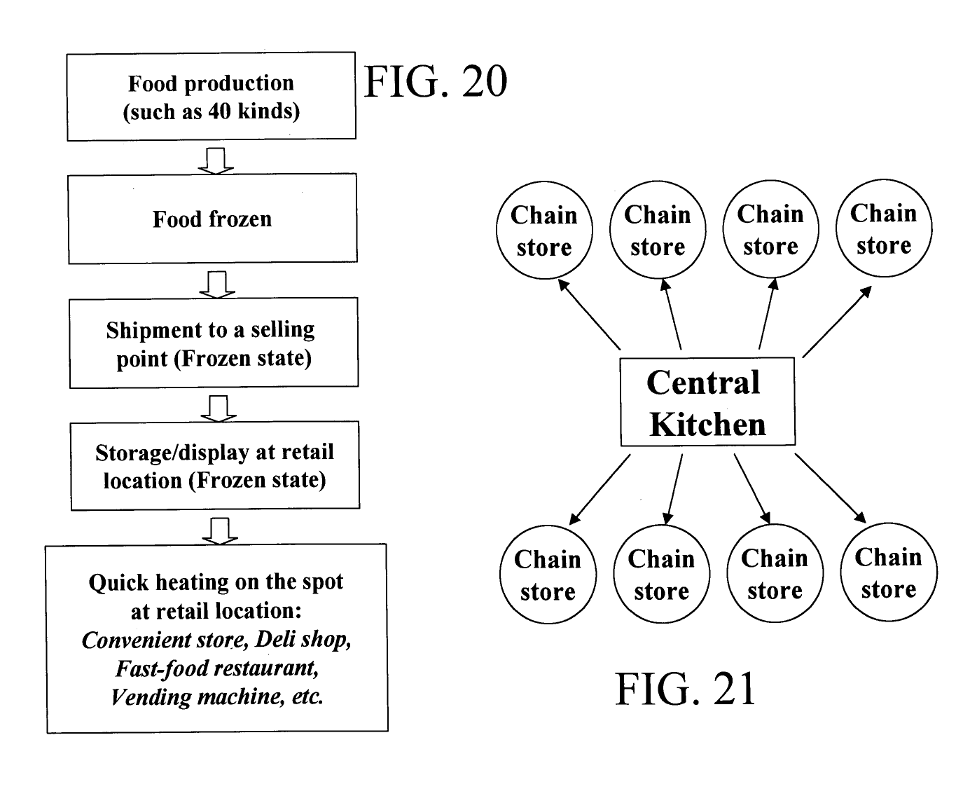

After 20, 40, or even 100 different kinds of oriental meals are manufactured and packaged in a factory, the packages could be frozen immediately, as depicted in a flowchart of FIG. 20.

Due to the unusual ways of preparing and cooking, it would be more economical for the production to be highly mechanized and automated. Otherwise, the quality would be poor, and very importantly, the manufacturing cost will be too high to be affordable to the consumers.

Accordingly, the production should be highly centralized, instead of being done in an individual fast-food restaurant, as depicted in FIG. 21.

It would be more convenient that the fast-food packs be frozen as soon as prepared, and kept in the frozen state through the shipment to a ‘retail location’, or ‘chain store’, and also during the storage and display in the retail locations, until they are being readied for consumption by consumers.

‘Retail locations’ are defined in this patent application as places where the fast-food packs are sold to consumers, and include convenient stores, fast-food restaurants, deli shops, vending trucks, automated vending machines, etc.

Obviously many modifications and variations of the present invention are possible in light of the above teachings. It is therefore to be understood that, within the scope of the appended claims, the invention may be practiced otherwise than as specifically described.

1. A novel Asian fast-food comprising an Asian meal (1) traditionally accompanied by cooked rice (3), and the accompanying cooked rice (3), in which the rice (3) is embodied to become a part of the container holding the Asian meal (1).

2. The invention according to claim 1, wherein the part is in a form of block (3a).

3. The invention according to claim 1, wherein the part is in a form of container (3t, 3u) with a recess to hold the Asian meal (1) in it.

4. The invention according to claim 1, wherein the part is coated with a film on the surface.

5. The invention according to claim 4, wherein the film is substantially rigid and sturdy.

6. The invention according to claim 4, wherein the film is made of flour.

7. The invention according to claim 3, wherein the rice is embodied into a shape resembling the hamburger buns.

8. The invention according to claim 7, wherein a recess (7) for holding the Asian meal is provided on the inner side of the bun.

9. The invention according to claim 7, wherein the two pieces of the buns are sealed together to make the fast-food pack substantially water-tight.

10. The invention according to claim 1, wherein the fast-food pack is in a frozen state.

11. A novel Asian fast-food comprising an Asian meal (1) traditionally accompanied by cooked rice (3), the accompanying cooked rice (3), and a wrap (5), in which the rice (3) is embodied to become a part of the container holding the Asian meal (1) with the aid of the wrap (5).

12. A method of manufacturing and distributing Asian fast-foods comprising an Asian meal (1) traditionally accompanied by cooked rice (3) and the accompanying cooked rice (3), in which the rice (3) is embodied to become a part of the container holding the Asian meal (1), and the Asian foods are frozen after being manufactured, and distributed to retail stores and restaurants in the frozen state.

13. The invention according to claim 1, wherein the retail restaurants belong to a restaurant chain system.
